(19) United States
(12) Patent Application Publication
(10) Pub. No.: US 2013/0085665 A1
(43) Pub. Date: Apr. 4, 2013

(54) CONTROLLING SYSTEM AND METHOD FOR APPOINTMENT

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/328,101

(22) Filed: Dec. 16, 2011

(30) Foreign Application Priority Data
Sep. 30, 2011 (TW) 100135424

(51) Int. Cl. G01C 21/34

(52) U.S. Cl. 701/412; 701/533; 701/410; 701/400; 701/465

(57) ABSTRACT

A controlling method for making and keeping appointments includes: inputting information concerning an appointment; finding out urban lines according to the starting point and the destination of the appointment, and obtaining detailed information of each urban line found, wherein the detailed information of each urban line is used to create the steps of the total journey whereby the user should arrive at the destination from the starting point at a particular time; selecting an urban line from the urban lines found; calculating when the user should leave according to the selected urban line and the detailed information of the selected urban line; and informing the user accordingly.

### BACKGROUND

1. Technical Field

The present disclosure relates to a controlling system and method for appointments.

2. Description of Related Art

Invitation cards for social gatherings may only show the host name, address of the venue of the social event, starting time and a route to the venue from a well known starting point. This information on the cards may not be adequate for some invitees. Therefore, there is room for improvement.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a controlling system for appointments.

FIGS. 2-5 are schematic diagrams of the controlling system of FIG. 1 in a state of use.

FIG. 6 is a flowchart of an exemplary embodiment of a controlling method.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

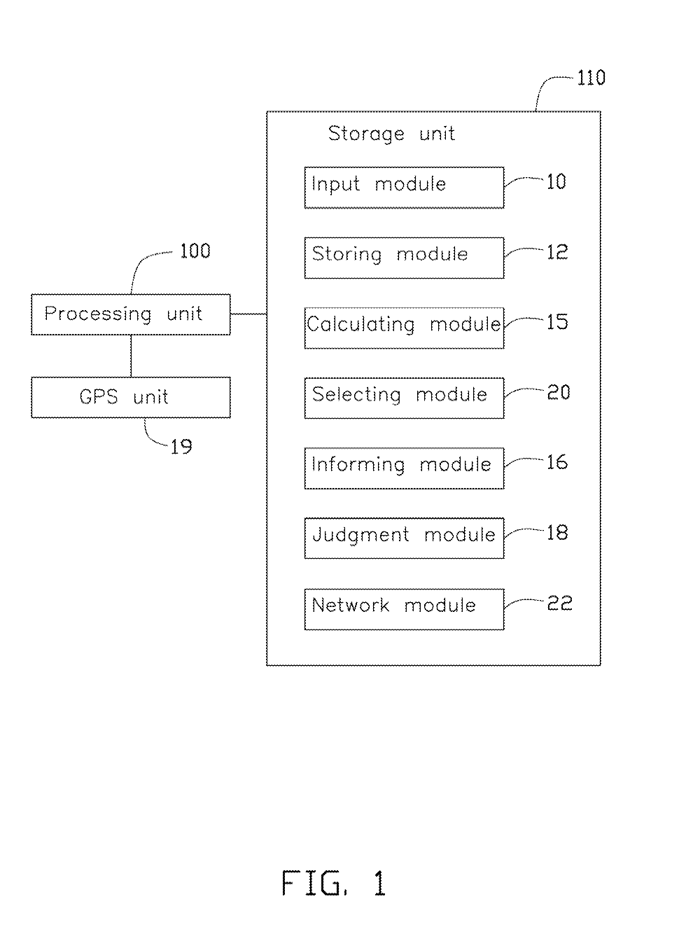

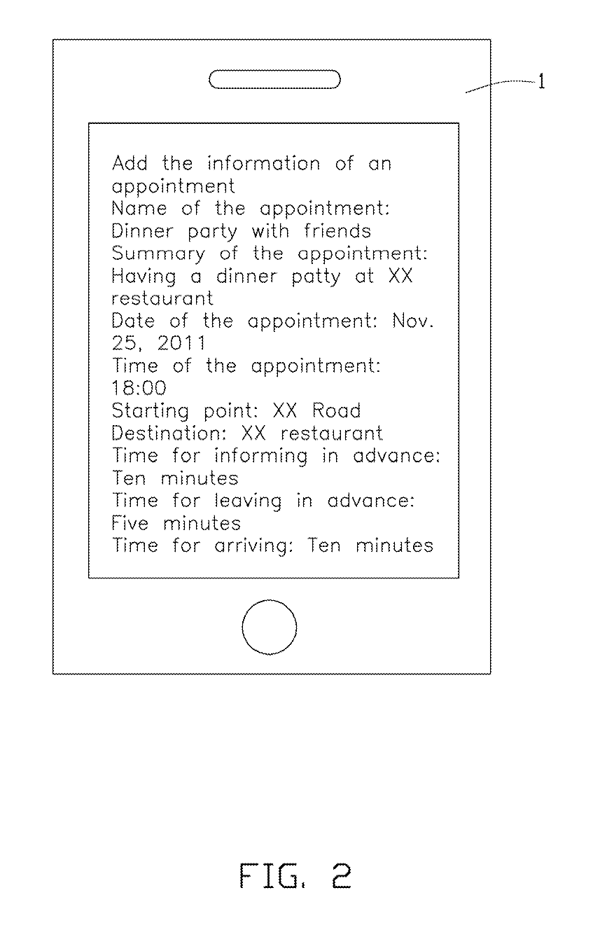

Referring to FIG. 1, an exemplary embodiment of a controlling system for assisting in the making and keeping of appointments includes a global positioning system (GPS) unit 19, a processing unit 100, and a storage unit 110. The storage unit 110 includes an input module 10, a storing module 12, a calculating module 15, a selecting module 20, an informing module 16, a network module 22, and a judgment module 18, which may include computer code to be executed by the processing unit 100. In this embodiment, the controlling system is present in a handheld device, such as a mobile phone 1 (shown in FIG. 2). A GPS receiver in the mobile phone 1 can be regarded as the GPS unit 19 of the controlling system.

The GPS unit 19 tracks the location of the mobile phone 1, and therefore the location of a user who holds the mobile phone 1. In the embodiment, the location of the mobile phone 1 can be recorded in terms of longitude and latitude.

Referring to FIG. 2, the input module 10 allows the input of information relating to an appointment (information of appointment). In the embodiment, the information of appointment includes a name of the appointment, a summary of the appointment, a date of the appointment, a time of the appointment, a starting point for journeying to the appointment, a destination of the appointment, a period of time for informing in advance, a period of time for leaving in advance, and a period of time for arriving at the destination in advance. The time of the appointment denotes when the user should arrive at the destination. The period of time for informing in advance is how much advance warning (i.e. how long beforehand) of future events or situations should the controlling system give to the user. The period of time for leaving in advance denotes how much time the user needs to prepare for leaving. The period of time for arriving in advance denotes the length of time before which the user should arrive at the destination.

As a matter of convenience, the user can choose an address or addresses on a map for setting the starting point and the destination of the appointment.

The storing module 12 stores a traffic map and information concerning the public transportation routes available through or in a city at various times (urban lines). The information of the urban lines includes bus and train stops and stations along each urban line, the journey times between stops and stations on each type of urban line, and the arrival times relating to each stop and station. The network module 22 enables communication between the mobile phone 1 and a server, such that the mobile phone 1 can download traffic maps and the information as to urban lines.

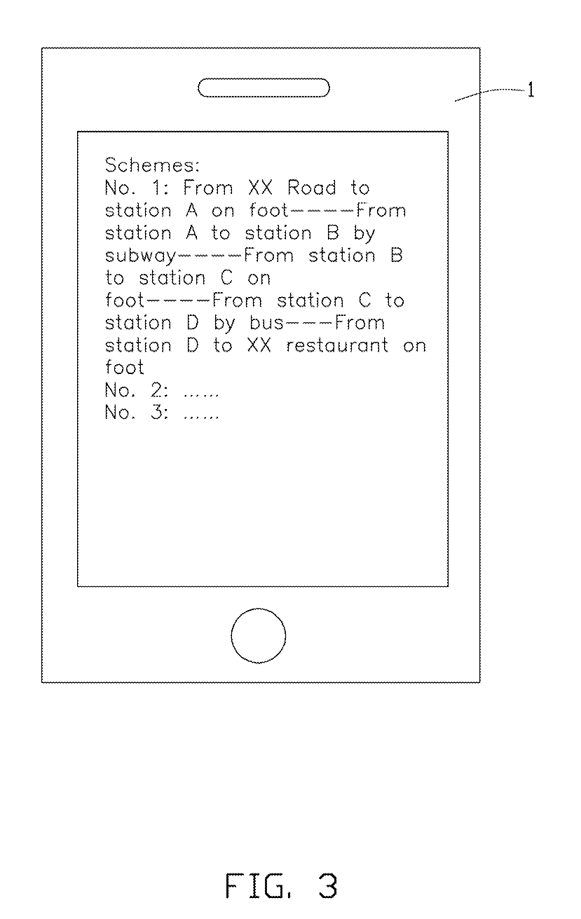

The calculating module 15 finds out relevant urban lines from the storing module 12 according to the starting point and the destination of the appointment. Referring to FIG. 3, the calculating module 15 further obtains detailed information concerning each type of urban line. The detailed information of each urban line includes the steps of arriving at the destination from the starting point, a period of time for each step, and a likely period of time before the user arrives at the destination from the starting point, in relation to each type of urban line. For example, the calculating module 15 may find out three schemes which satisfy the requirements of a particular appointment. A first scheme includes the following steps: arriving at a station A from the starting point on foot, which walking takes five minutes; arriving at a station B by subway from the station A, which journey takes eight minutes; arriving at a station C from the station B on foot, which walking takes six minutes; arriving at a station D from the station C by bus, which takes twenty minutes; arriving at the destination of the appointment from the station D on foot, which walking takes eleven minutes. As a result, the first scheme requires fifty minutes.

The selecting module 20 selects one of the schemes. The calculating module 15 further establishes when the user must leave according to the time of the appointment, the period of time for informing in advance, the period of time for leaving in advance, the period of time for arriving in advance, and the detailed information of the selected urban line.

For example, if the time of the appointment is 18:00, and the period of time for leaving in advance is five minutes, the period of time for arriving in advance is ten minutes, and the selected urban line is the first scheme calculated. Furthermore, in the storing module 12, the departure times from the subway station A may be 07:03, 07:08, . . ., 16:53, 16:58, and 17:03, namely the subway leaves from the station A every five minutes. The departure times from the station C may be 07:05, 07:15, . . . , 17:25, and 17:35, namely a bus leaves from the stop or station C every ten minutes.

According to the information described above, the calculating module 15 can establish when the user must leave. Specifically, at the first step, the calculating module 15 estimates that the user should arrive at the destination for the appointment at 17:50 according to the time of the appointment and the period of time for arriving in advance. At the second step, the calculating module 15 estimates that the user should arrive at the station D at 17:39 based on the time when the user should arrive at the destination and the period of time likely required from the station D to the destination. At the third step, the calculating module 15 makes calculations based on the bus leaving from the stop or station C at 17:19 according to the time when the user arrives at the stop or station D and how long the bus will take to arrive at the stop or station D from the stop or station C. At the fourth step, the calculating module 15 estimates that the user should arrive at the stop or station C at 17:15 according to the time when the bus leaves from the stop or station C. At the fifth step, the calculating module 15 estimates that the user should arrive at the stop or station B at 17:09 according to the time of the user arriving at the stop or station C and the period taken for the user to arrive at the stop or station C from the stop or station B on foot. At the sixth step, the calculating module 15 makes calculations based on the subway leaving from the station A at 17:01 according to the arrival time of the user at the station B and the journey time between the station A and the station B. At the seventh step, the calculating module 15 calculates that the user should arrive at the station A at 16:58 according to the departure time of the subway from the station A. At the eighth step, the calculating module 15 decides that the user should leave from the starting point at 16:53 according to the time of arrival of the user at the station A and the period of time taken from the starting point to the station A. At the ninth step, the calculating module 15 estimates that the user must leave from the starting point at 16:48 according to the amount of time for leaving in advance. Accordingly, the calculating module 15 establishes that the informing module 16 must inform the user to begin at 16:38, according to the amount of time for informing in advance and the actual departure time from the starting point.

In the embodiment, the nine steps for establishing the time at which the informing module 16 must inform the user are examples of the operation of the controlling system. In other embodiments, the calculating module 15 can make calculations and establish times and periods in other ways.

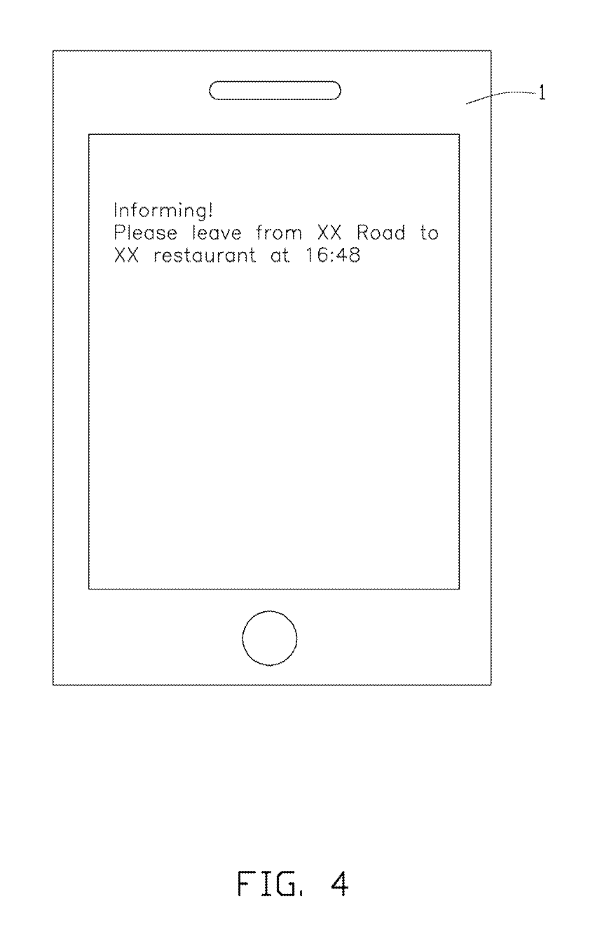

Referring to FIG. 4, the informing module 16 informs the user by means of an alarm or a displayed message at 16:38.

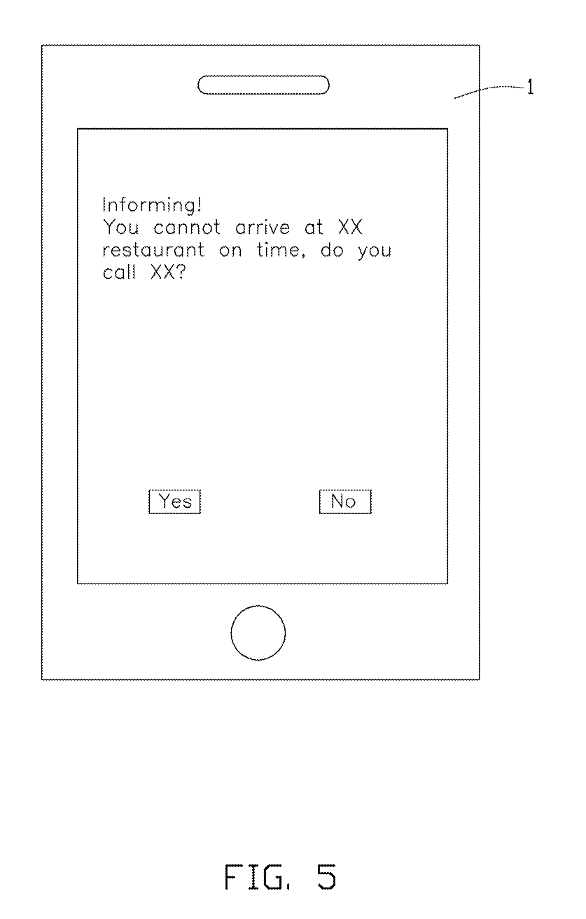

The judgment module 18 reads the GPS location of the mobile phone 1 as tracked by the GPS unit 19, and determines whether the user can accomplish the required steps according to the location of the mobile phone 1 and the current time. For example, if the GPS unit 19 knows that the user is at the station C at 17:13, according to the fourth step, the judgment module 18 can determine that the user can arrive at the destination on time. If the GPS unit 19 confirms that the user is at the station B at 17:30, according to the fifth step, the judgment module 18 determines that the user is not able to arrive at the destination on time. In this situation, the calculating module 15 may explore alternative arrangements and find out whether there is another urban line which will allow the user to arrive at the destination on time within the time remaining. If there is another urban line from the present location of the user, the informing module 16 invites the user to choose the other urban line. As shown in FIG. 5, if there is no other urban line available to allow the user to arrive at the destination on time, the informing module 16 may warn the user that he will not arrive at the destination on time. The user can call to make an apology or other arrangement.

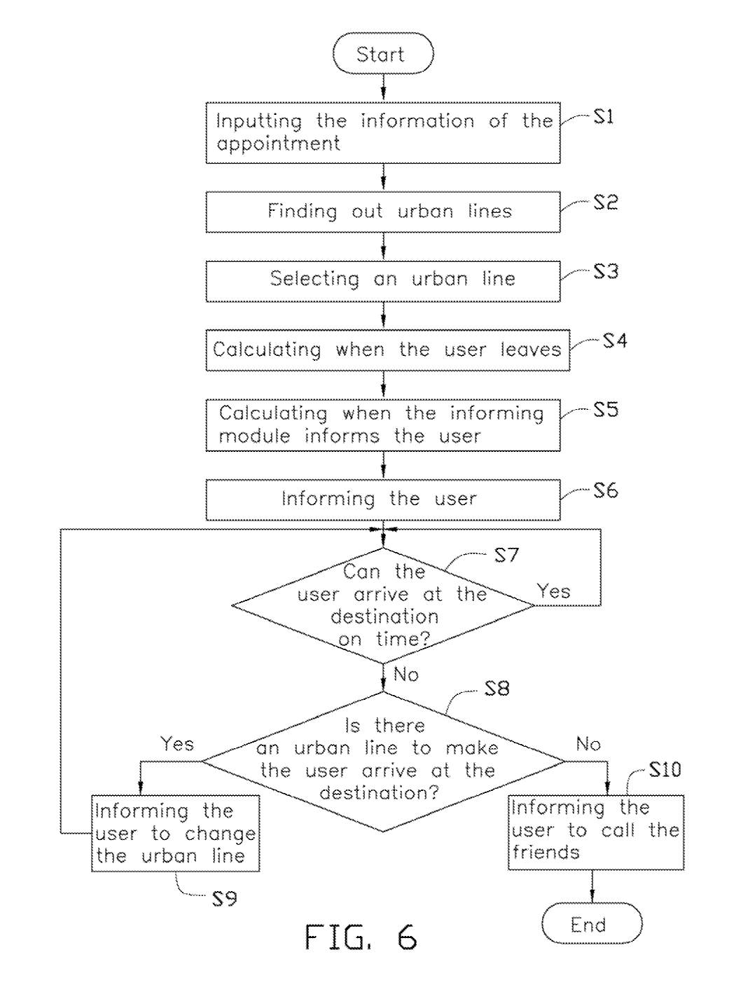

Referring to FIG. 6, an exemplary embodiment of a controlling method includes the following steps.

In step S1, the information of appointment is input through the input module 10. In the embodiment, the information of appointment includes a name of the appointment, a summary of the appointment, a date of the appointment, a time of the appointment, a starting point in relation to the appointment, the location of the appointment, a notice time in advance, a period of time for leaving in advance, and a period of time for arriving before the appointment. The time of the appointment denotes the latest time for the user arriving at the destination. The period of time for informing in advance denotes how much warning of events and situations the controlling system gives to the user in advance. The period of time for leaving in advance denotes how much time the user needs to prepare for leaving. The period of time for arriving in advance denotes a period of time before which the user should arrive at the destination.

In step S2, the calculating module 15 finds out the relevant urban lines from the storing module 12 according to the starting point and the location of the appointment, to ensure that the user can arrive at the destination from the starting point by using the relevant urban lines.

In step S3, the selecting module 20 selects one of the urban lines.

In step S4, the calculating module 15 estimates the time when the user must leave according to the time of the appointment, the period of time for informing in advance, the period of time for leaving in advance, the period of time for arriving in advance, and the detailed information concerning the selected urban line.

In step S5, the calculating module 15 calculates when the informing module 16 should give warning to the user according to the amount of notice in advance and the time the user is to leave from the starting point.

In step S6, the informing module 16 warns the user by means of alarm or a displayed message.

In step S7, the judgment module 18 constantly reads the location of the mobile phone 1 tracked by the GPS unit 19, and determines whether the user can make the appointment as desired by taking the necessary steps according to the current location of the mobile phone 1. If the judgment module 18 determines that the user can arrive at the destination of the appointment on time, step S7 is repeated, namely the judgment module 18 continues to determine the progress of the user. If the judgment module 18 determines at any time that the user will not arrive at the destination on time, the process flows to step S8.

In step S8, the calculating module 15 finds out whether there is another available urban line taking account of the time remaining. If there is another available urban line which is likely to succeed, the process flows to step S9. If there is no other urban line which can make the user arrive at the destination of the appointment on time, the procedure moves to step S10.

In step S9, the informing module 16 invites the user to choose the other urban line.

In step S10, the informing module 16 informs the user that the appointment cannot be kept on time.

The foregoing description of the exemplary embodiments of the disclosure has been presented only for the purposes of illustration and description and is not intended to be exhaustive or to limit the disclosure to the precise forms disclosed. Many modifications and variations are possible in the light of everything above. The embodiments were chosen and described in order to explain the principles of the disclosure and their practical application so as to enable others of ordinary skill in the art to utilize the disclosure and various embodiments, with such various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than by the foregoing description and the exemplary embodiments described therein.

What is claimed is:

1. A controlling system for an appointment, comprising:
a processing unit; and
a storage unit connected to the processing unit and storing a plurality of programs to be executed by the processing unit, wherein the storage unit comprises:
an input module to input information of the appointment, wherein the information of appointment comprises a time of the appointment, a starting point for journeying to the appointment, and a destination of the appointment;
a storing module storing a traffic map and information concerning urban lines, wherein the information of the urban lines comprises bus and train stops and stations along each urban line and the journey times between stops and stations on each type of urban line;
a calculating module to find out corresponding urban lines from the storing module according to the starting point and the destination of the appointment, and obtain detailed information concerning each type of urban line, wherein the detailed information of each urban line comprises steps of arriving at the destination from the starting point, a period of time for each step, and a period of time before the user arrives at the destination from the starting point in relation to each type of urban line;
a selecting module to select an urban line from the found urban lines, wherein the calculating module further establishes when the user must leave from the starting point according to the selected urban line and the detailed information of the selected urban line; and
an informing module to inform the user according to the calculation result of the calculating module.

2. The controlling system of claim 1, wherein the information of the appointment further comprises a period of time for leaving in advance or a period of time for arriving in advance, the calculating module further establishes when the user should leave from the starting point according to the detailed information of the selected urban line, the period of time for leaving in advance or the period of time for arriving in advance.

3. The controlling system of claim 1, wherein the information of the appointment further comprises a period of time for informing in advance, the calculating module further establishes when the informing module should inform the user according to the period of time when the user leaves from the starting point and the period of time for informing in advance.

4. The controlling system of claim 1, wherein the storing module further stores arrival times relating to each stop and station, the calculating module further establishes when the user should leave from the starting point according to the information of the selected urban line and the information input through the input module.

5. The controlling system of claim 1, further comprising a global positioning system (GPS) unit, wherein the storage unit further comprises a judgment module, the GPS unit tracks a location of the user, the judgment module determines whether the user can arrive at the destination of the appointment on time according to the location from the GPS unit, the current time, and the detailed information of the selected urban line; if the judgment module determines that the user cannot arrive at the destination of the appointment on time, the informing module informs the user that the user cannot arrive at the destination of the appointment on time.

6. The controlling system of claim 5, wherein if the judgment module determines that the user cannot arrive at the destination of the appointment on time, the calculating module further finds out whether there is another urban line to make the user arrive at the destination of the appointment on time according to the rest time, if there is another urban line to make the user arrive at the destination of the appointment, the informing module informs the user to choose the another urban line.

7. A controlling method for an appointment, comprising:
inputting information of the appointment, wherein the information of the appointment comprises time of the appointment, a starting point of the appointment, and a destination of the appointment;
finding out corresponding urban lines according to the starting point and the destination of the appointment, and establishing detailed information of each urban line found, wherein the detailed information of each urban line comprises steps of arriving at the destination from the starting point, a period of time for each step, and a period of time before the user arrives at the destination from the starting point in relation to each type of urban line;
selecting an urban line from the founded urban lines;
establishing when the user should leave from the starting point according to the selected urban line and the detailed information of the selected urban line; and
informing the user accordingly.

8. The controlling method of claim 7, further comprising:
tracking a location of the user through a global positioning system (GPS) unit;
determining whether the user can arrive at the destination of the appointment on time according to the location from the GPS unit, the current time, and the detailed information of the selected urban line; and
informing the user that the user cannot arrive at the destination of the appointment on time if the user cannot arrive at the destination of the appointment on time.

9. The controlling method of claim 8, further comprising:
finding out whether there is another urban line to make the user arrive at the destination of the appointment on time according to the rest time; and
informing the user to choose the another urban line if there is another urban line to make the user arrive at the destination of the appointment.
